(19) United States
(12) Patent Application Publication
(10) Pub. No.: US 2025/0052100 A1
(43) Pub. Date: Feb. 13, 2025

(54) FITTING FOR MOVABLY MOUNTING A FURNITURE PART

(71) Applicant: Julius Blum GmbH, Hoechst (AT)

(72) Inventors: Christof GOETZ, Lustenau (AT); Stefan DUER, Schwarzach (AT)

(21) Appl. No.: 18/929,029

(22) Filed: Oct. 28, 2024

Related U.S. Application Data
(63) Continuation of application No. PCT/AT2023/060116, filed on Apr. 5, 2023.

(30) Foreign Application Priority Data
Apr. 29, 2022 (AT) A 50294/2022

(51) Int. Cl. E05D 5/02; E05D 15/26; E05D 15/58

(52) U.S. Cl. CPC E05D 5/0223; E05D 15/26; E05D 15/58; E05Y 2600/51; E05Y 2600/624; E05Y 2600/632; E05Y 2900/20

(57) ABSTRACT

A fitting for movably mounting a furniture part, a door, or a window on a support structure, includes a first fitting part to be connected to the furniture part, the door, or the window, and at least one second fitting part to be connected to the support structure. At least one securing device can secure the first fitting part to the second fitting part. The securing device includes a first component with at least one thread-free section and a threaded section and a second component with at least one mating thread. The thread-free section, the threaded section, and the mating thread are arranged on the two components of the securing device such that the mating thread contacts the thread-free section in a sliding position and is engaged with the threaded section in an engagement position.

The present application is a continuation of International Application PCT/AT2023/060116 filed on Apr. 5, 2023. Thus, all of the subject matter of International Application PCT/AT2023/060116 is incorporated herein by reference.

### BACKGROUND OF THE INVENTION

The invention relates to a fitting for movably mounting a furniture part, a door or a window on a support structure. The invention furthermore relates to a piece of furniture with at least one support structure, which preferably has a shaft-like cavity, at least one such fitting and at least one furniture part, movably mounted on the support structure by means of the fitting, which is preferably formed as a folding door or folding sliding door. And finally, the invention relates to a method for movably mounting a furniture part, a door or a window on a support structure by at least one such fitting.

A fitting for movably mounting a furniture part on a support structure is known from AT 521365. However, a disadvantage of this fitting is that it has a technically complicated design, which makes the fastening of the two fitting parts more difficult. The more complex the fastening is, the higher is also the risk of incorrect operation.

### SUMMARY OF THE INVENTION

The object of the invention is to at least partly overcome the disadvantages known from the state of the art and in particular to specify a fitting which is characterized by increased operator convenience, above all during installation. Furthermore, a piece of furniture with at least one fitting improved in such a way as well as a method for movably mounting a furniture part, a door or a window on a support structure by means of at least one fitting improved in such a way are to be specified.

Accordingly, in the case of the fitting for movably mounting a furniture part, a door or a window on a support structure, it is provided that the fastening device comprises at least one first component with at least one threadless section and at least one threaded section and at least one second component with at least one mating thread, wherein the threadless section, the threaded section and the mating thread are arranged on the two components of the fastening device such that the mating thread is in contact with the threadless section in a displacement position and is engaged with the threaded section in an engagement position.

In this way, the two components of the fastening device can be quickly and easily joined in the displacement position and then connected to each other in the engagement position. The installation procedure is thereby made easier, in particular when more than one fastening device is provided and/or the furniture part, window or the door mounted on the first fitting part has a high weight. A toolless fastening of the two fitting parts is also possible in this way.

According to advantageous embodiments, the first component of the fastening device is formed as a nut, preferably as a press nut, and/or is arranged in or on the second fitting part.

Alternatively or in addition, the first component has a substantially cylindrical internal wall and the threadless section and the threaded section are arranged on the internal wall, and/or the first component has a channel, which runs diagonally with respect to a longitudinal axis of the first component and on which the threadless section is arranged.

With regard to the second component of the fastening device, it has proved to be favorable for the second component to be formed as a screw, preferably as a knurled screw, and/or to be able to be brought into contact with the first fitting part.

It has proved to be particularly advantageous for the mating thread to be able to be transferred out of the displacement position into the engagement position by a pivoting movement. Preferably the pivoting movement can be carried out manually and/or by a limit stop of one of the two components against a counter limit stop.

It can be provided that the threaded section has a first longitudinal axis and the mating thread has a second longitudinal axis. The two longitudinal axes enclose an acute angle, preferably between 5° and 15°, in the displacement position and are arranged substantially parallel to each other in the engagement position.

To increase the reliability of the fastening, the threaded section and/or the mating thread have at least one glue dot with which the two components of the fastening device can be glued together in the engagement position, preferably wherein the glue dot consists of a glue which can be activated by a mechanical load.

Alternatively or in addition, it is advantageous that the two fitting parts rest predominantly flat against each other when fastened, and/or wherein at least one additional fixing means, separate from the fastening device, with which the two fitting parts can be fixed is provided.

As stated at the outset, protection is also sought for a piece of furniture with at least one support structure, which preferably has a shaft-like cavity, at least one fitting according to the invention and at least one furniture part, movably mounted on the support structure by means of the fitting, which is preferably formed as a folding door or folding sliding door.

The method for movably mounting a furniture part, a door or a window on a support structure by means of at least one fitting according to the invention comprises the following method steps, which are preferably chronological in the specified order: the second fitting part is connected to the support structure, the furniture part, the door or the window is connected to the first fitting part, the first fitting part is fastened to the second fitting part by means of the at least one fastening device, wherein the mating thread is displaced relative to the threadless section in the displacement position, is then transferred into the engagement position, preferably by a pivoting movement, and in the engagement position is finally moved by a rotational movement relative to the threaded section until the two fitting parts are fixed to each other.

### BRIEF DESCRIPTION OF THE DRAWINGS

Further details and advantages of the invention are explained in more detail below with reference to the drawings, in which:

FIGS. 1, 2 show a piece of furniture with a movable furniture part in the form of a door which is represented in two pivot positions,

FIGS. 3, 4 show the piece of furniture according to FIG. 2 from a different viewing direction, wherein an enlarged section is represented in FIG. 4,

FIG. 5 shows a first embodiment of the fitting,

FIGS. 6, 7 show a second embodiment of the fitting, wherein an enlarged section is represented in FIG. 7,

FIGS. 8, 9, 10 show the second embodiment of the fitting in different cross-sectional representations, wherein FIG. 9 shows an enlarged section from FIG. 8, and

FIGS. 11-14 show a fastening device in different relative positions of the two components.

### DETAILED DESCRIPTION OF THE INVENTION

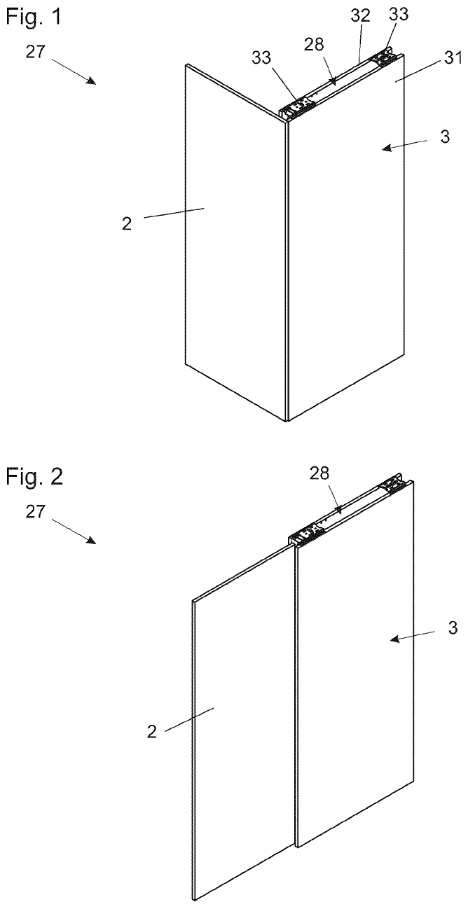

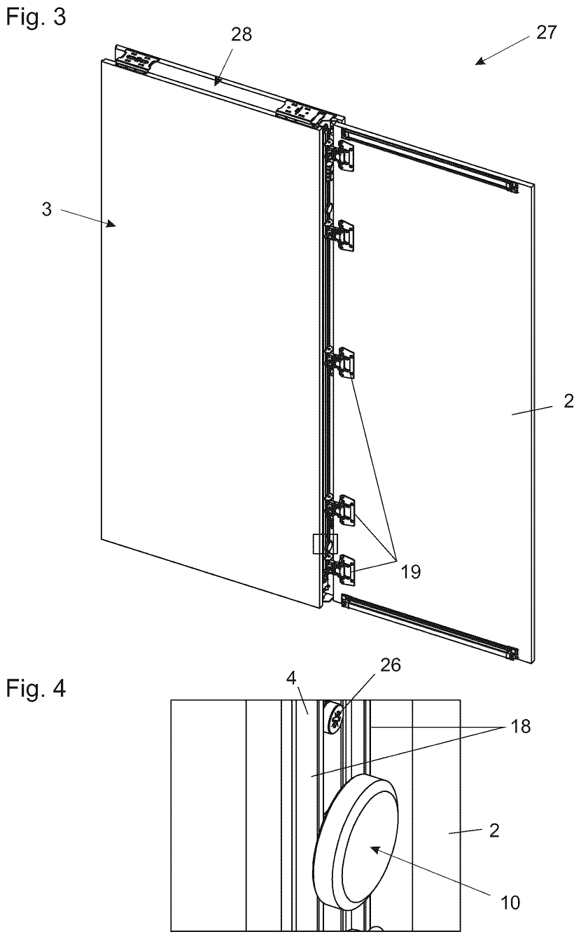

A piece of furniture 27 with a movable furniture part 2 in the form of a folding door is represented in FIGS. 1 to 4. The furniture part 2 can, e.g., also be formed as a folding sliding door.

The piece of furniture 27 comprises a support structure 3, which can be formed, as in the case represented, as a shaft-like cavity 28. This cavity 28 can be formed e.g. of a first furniture wall 31 and a second furniture wall 32, which are arranged substantially parallel to each other. The two furniture walls 31, 32 can be connected to each other by one or more connection devices 33.

The furniture part 2 can be arranged in a position substantially transverse to the support structure 3 (cf. FIG. 1), in a position substantially parallel to the support structure 3 (cf. FIG. 2) and in all intermediate positions. Furthermore, the furniture part 2 can also be arranged in the cavity 28 at least in areas. In the position substantially transverse to the support structure 3, the furniture part 2 can cover a different furniture part at least in areas, e.g. a piece of kitchen furniture and/or kitchen appliance.

The furniture part 2 is movably mounted on the support structure 3 via at least one fitting 1 (cf. the subsequent figures). For this, hinge 19 can be provided which are connected to the furniture part 2 on one side and to a second fitting part 5 of the fitting 1 on the other side. The furniture part 2 can be pivoted relative to the support structure 3 via the hinges 19.

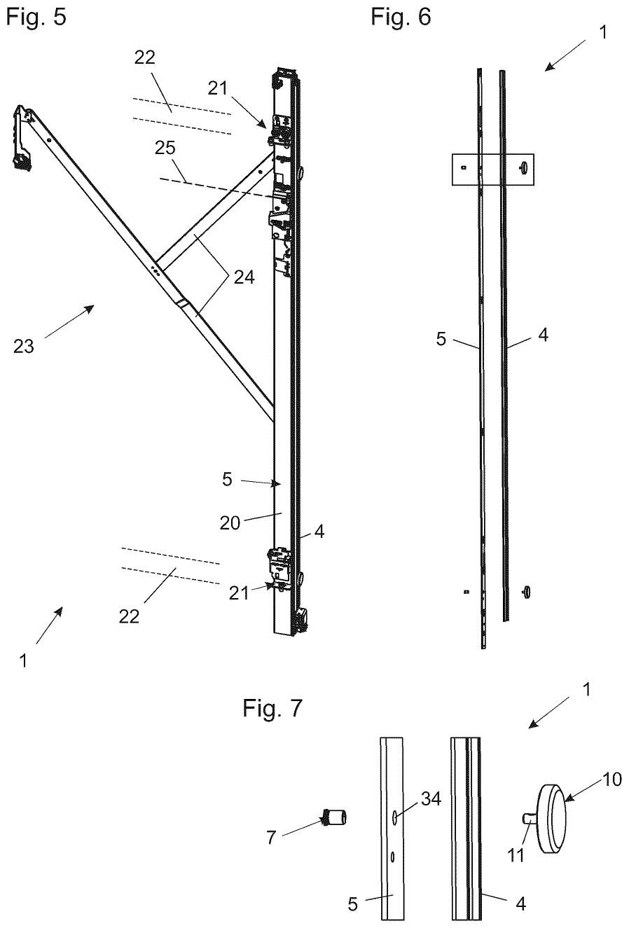

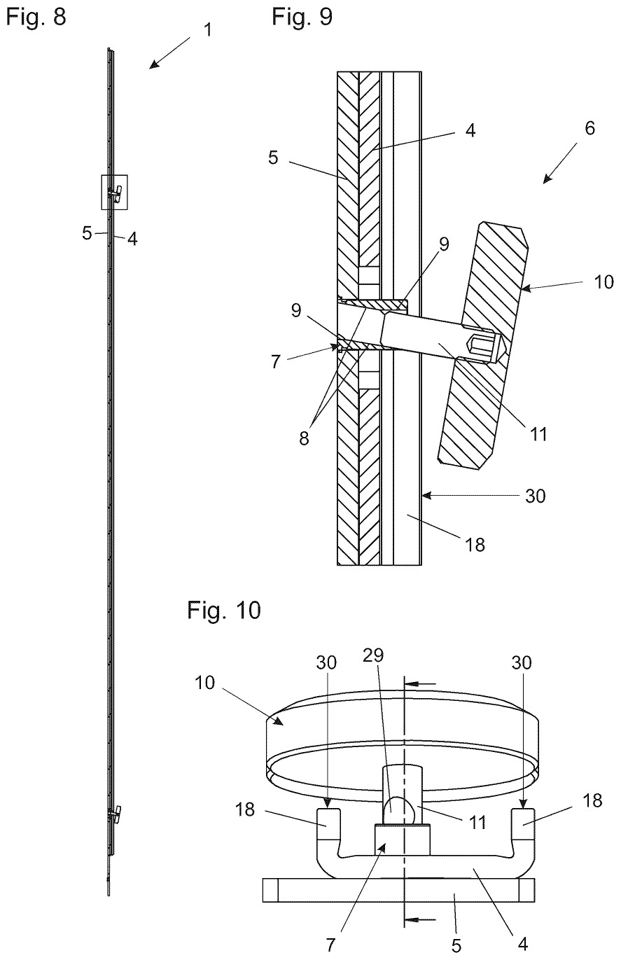

FIG. 5 et seq. show details of the fitting 1 and the fastening device 6.

The fitting 1 for movably mounting a furniture part 2, a door or a window on a support structure 3 comprises a first fitting part 4, which can be connected or is connected to the furniture part 2, the door or the window, and at least one second fitting part 5, which can be connected or is connected to the support structure 3, wherein at least one fastening device 6 is provided with which the first fitting part 4 can be fastened to the second fitting part 5.

The fastening device 6 comprises at least one first component 7 with at least one threadless section 8 and at least one threaded section 9 and at least one second component 10 with at least one mating thread 11, wherein the threadless section 8, the threaded section 9 and the mating thread 11 are arranged on the two components 7, 10 of the fastening device 6 such that the mating thread 11 is in contact with the threadless section 8 in a displacement position and is engaged with the threaded section 9 in an engagement position.

More than one, preferably two (as in the cases represented) or three fastening devices 6 can be provided with which the first fitting part 4 can be fastened to the second fitting part 5.

The second fitting part 5 can comprise a longitudinally extended support 20 (cf. FIG. 5).

At least one guide device 21, connectable or connected to the second fitting part 5, and at least one guide rail 22, on which the guide device 21 is displaceably mountable or mounted, can be provided. The guide rails 22, which are indicated schematically in FIG. 5, can be arranged e.g. on the furniture wall 32.

In the case of the embodiment represented in FIG. 5, the fitting 1 comprises at least one compensation device 23 for compensating for a tilting moment, wherein the compensation device 23 can be connected to the second fitting part 5, preferably wherein the compensation device 23 comprises at least one preferably Y-shaped scissor-type support 24 and/or at least one cable pull 25.

The first component 7 of the fastening device 6 can be formed as a nut, preferably as a press nut, and/or be arranged in or on the second fitting part 5. An opening 34 for mounting the nut can be provided in or on the second fitting part 5.

The second component 10 of the fastening device 6 can be formed as a screw, preferably as a knurled screw, and/or be able to be brought into contact with the first fitting part 4.

As is represented e.g. in FIGS. 9 and 10, the first fitting part 4 can have at least one, preferably several interfaces 18 for the preferably releasable fastening of a hinge 19, and/or be formed as a steel profile, and/or be formed substantially C-shaped in a cross section.

One or more bars of the first fitting part 4, on which one or more hinges 19 can be fastened, can function as interface 18.

The two fitting parts 4, 5 can rest predominantly flat against each other when fastened.

As can be seen from FIG. 4, at least one additional fixing means 26, separate from the fastening device 6, with which the two fitting parts 4, 5 can be fixed can optionally be provided.

Alternatively or in addition, it can optionally be provided that the threaded section 9 and/or the mating thread 11 have at least one glue dot 29 with which the two components 7, 10 of the fastening device 6 can be glued together in the engagement position, preferably wherein the glue dot 29 consists of a glue which can be activated by a mechanical load. Such a glue dot is indicated by way of example in FIG. 10 and serves to secure the component 10.

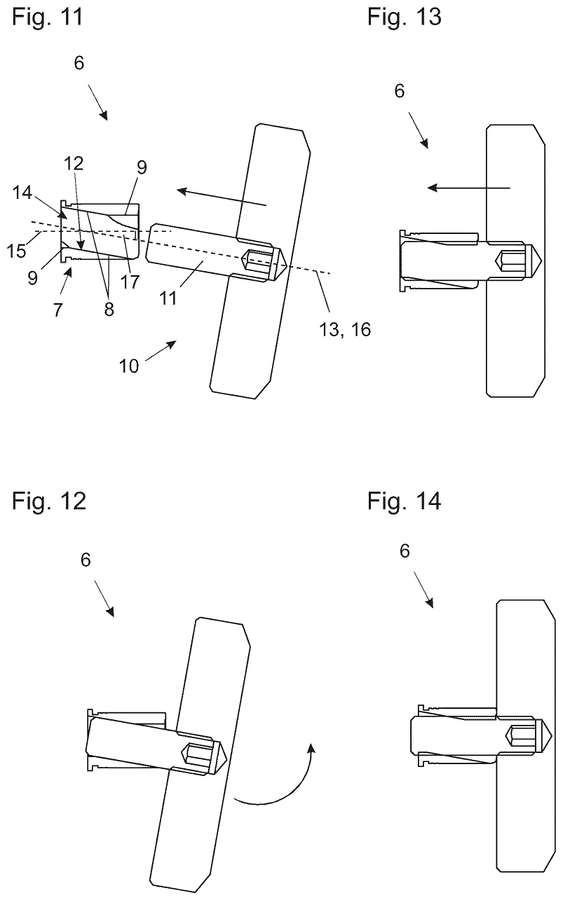

FIGS. 11 to 14 show a fastening device in different relative positions of the two components 7, 10.

The first component 7 has a substantially cylindrical internal wall 12 and the threadless section 8 and the threaded section 9 are arranged on the internal wall 12.

The first component 7 has a channel 14, which runs diagonally with respect to a longitudinal axis 13 of the first component 7 and on which the threadless section 8 is arranged.

The mating thread 11 can be transferred out of the displacement position into the engagement position by a pivoting movement, preferably wherein the pivoting movement can be carried out manually and/or by a limit stop of one of the two components 7, 10 against a counter limit stop 30. For example, a bar of the first fitting part 4 can function as a limit stop.

The threaded section 9 has a first longitudinal axis 15 and the mating thread 11 has a second longitudinal axis 16, wherein the two longitudinal axes 15, 16 enclose an acute angle 17, preferably between 5° and 15°, in the displacement position and are arranged substantially parallel to each other in the engagement position.

A method for movably mounting a furniture part 2, a door or a window on a support structure 3 by means of at least one fitting 1 can be characterized by the following method steps, which are preferably chronological in the specified order: the second fitting part 5 is connected to the support structure 3, the furniture part 2, the door or the window is connected to the first fitting part 4, and the first fitting part 4 is fastened to the second fitting part 5 by means of the at least one fastening device 6, wherein the mating thread 11 is displaced relative to the threadless section 8 in the displacement position, is then transferred into the engagement position, preferably by a pivoting movement, and in the engagement position is finally moved by a rotational movement relative to the threaded section 9 until the two fitting parts 4, 5 are fixed to each other.

1. A fitting for movably mounting a furniture part, a door or a window on a support structure, comprising:
a first fitting part to be connected or is connected to the furniture part, the door or the window,
at least one second fitting part to be connected or is connected to the support structure,
at least one fastening device with which the first fitting part can be fastened to the second fitting part, the fastening device comprising at least one first component with at least one threadless section and at least one threaded section and at least one second component with at least one mating thread, wherein the threadless section, the threaded section and the mating thread are arranged on the two components of the fastening device such that the mating thread is in contact with the threadless section in a displacement position and is engaged with the threaded section in an engagement position,
wherein the first component has a channel running diagonally with respect to a longitudinal axis of the first component and on which the threadless section is arranged.

2. The fitting according to claim 1, wherein the first component of the fastening device is formed as a nut, preferably as a press nut, and/or is arranged in or on the second fitting part.

3. The fitting according to claim 1, wherein the first component has a substantially cylindrical internal wall and the threadless section and the threaded section are arranged on the internal wall.

4. The fitting according to claim 1, wherein the second component of the fastening device is formed as a screw, preferably as a knurled screw, and/or can be brought into contact with the first fitting part.

5. The fitting according to claim 1, wherein the mating thread can be transferred out of the displacement position into the engagement position by a pivoting movement, preferably wherein the pivoting movement can be carried out manually and/or by a limit stop of one of the two components against a counter limit stop.

6. The fitting according to claim 1, wherein the threaded section has a first longitudinal axis and the mating thread has a second longitudinal axis, and wherein the two longitudinal axes enclose an acute angle, preferably between 5° and 15°, in the displacement position and are arranged substantially parallel to each other in the engagement position.

7. The fitting according to claim 1, wherein more than one, preferably two or three, fastening devices are provided with which the first fitting part can be fastened to the second fitting part.

8. The fitting according to claim 1, wherein the first fitting part:
has at least one, preferably several interfaces for the preferably releasable fastening of a hinge, and/or
is formed as a steel profile, and/or
is formed substantially C-shaped in a cross section.

9. The fitting according to claim 1, wherein the second fitting part comprises a longitudinally extended support.

10. The fitting according to claim 1, wherein at least one guide device, connectable or connected to the second fitting part, and at least one guide rail, on which the guide device is displaceably mountable or mounted, are provided and/or wherein at least one compensation device, which can be connected to the second fitting part, is provided for compensating for a tilting moment, preferably wherein the compensation device comprises at least one preferably Y-shaped scissor-type support and/or at least one cable pull.

11. The fitting according to claim 1, wherein the threaded section and/or the mating thread have at least one glue dot with which the two components of the fastening device can be glued together in the engagement position, preferably wherein the glue dot consists of a glue which can be activated by a mechanical load.

12. The fitting according to claim 1, wherein the two fitting parts rest predominantly flat against each other when fastened, and/or wherein at least one additional fixing means, separate from the fastening device, is provided with which the two fitting parts can be fixed.

13. A piece of furniture with at least one support structure, which preferably has a shaft-like cavity, at least one fitting according to claim 1, and at least one furniture part, movably mounted on the support structure by means of the fitting, which is preferably formed as a folding door or folding sliding door.

14. A method for movably mounting a furniture part, a door or a window on a support structure by means of at least one fitting according to claim 1, comprising the following method steps, which are preferably chronological in the specified order:
the second fitting part is connected to the support structure,
the furniture part, the door or the window is connected to the first fitting part,
the first fitting part is fastened to the second fitting part by means of the at least one fastening device, wherein the mating thread is displaced relative to the threadless section in the displacement position, is then transferred into the engagement position, preferably by a pivoting movement, and in the engagement position is finally moved by a rotational movement relative to the threaded section until the two fitting parts are fixed to each other.
